(19) United States
(12) Patent Application Publication
(10) Pub. No.: US 2025/0151751 A1
(43) Pub. Date: May 15, 2025

(54) PROCESS FOR PREPARING HYBRID MEAT ANALOGUE

(71) Applicant: MASSEY VENTURES LIMITED, Palmerston North (NZ)

(72) Inventors: Jaspreet Singh, Palmerston North (NZ); Lovedeep Kaur, Palmerston North (NZ); Boning Mao, Palmerston North (NZ); Akashdeep Beniwal, Palmerston North (NZ); Olawunmi Oladeji, Palmerston North (NZ); Harjinder Singh, Palmerston North (NZ)

(21) Appl. No.: 18/722,869

(22) PCT Filed: Dec. 21, 2022
(86) PCT No.: PCT/IB2022/062646

§ 371 Date: Jun. 21, 2024

(30) Foreign Application Priority Data
Dec. 22, 2021 (NZ) 783717

(51) Int. Cl. A23J 3/22; A23J 3/04; A23J 3/14; A23L 5/10; A47J 27/17; A47J 43/04

(52) U.S. Cl. CPC A23J 3/227; A23J 3/04; A23J 3/14; A23L 5/17; A47J 27/17; A47J 43/04

(57) ABSTRACT

The invention relates to a texturised hybrid meat analogue comprising both plant and animal protein, and a method of preparing the same. The texturised hybrid meat analogue is comparable to meat in terms of its textural and nutritional properties.

### 1. FIELD OF THE INVENTION

The invention relates to a texturised hybrid meat analogue that comprises both plant and animal protein and a method for preparing the same.

### 2. BACKGROUND OF THE INVENTION

As the population of the world increases, there is a growing demand for nutritious food. Meat has historically been an integral part of many human diets, providing energy and proteins for growth and maintenance of the human body. However, current environmental and animal welfare concerns have led many individuals to question their meat consumption. Many people, while not wanting to adopt a strict vegetarian diet, would like to minimize the negative consequences of meat consumption, both in terms of personal health and the environment, while still enjoying the benefits of meat consumption. Consequently, demand is increasing for plant-based hybrid foods that are “satisfying” substitutes for meat and that, due to differences in production chains, will help alleviate predicted food and environmental crises.

“Meat analogues” are a category of food products that resemble real meat in texture and appearance. Meat analogues are generally made from plant-based materials alone but may contain a small amount of meat.

It is the fibrous, texturised structure of meat that gives it its unique sensory and textural properties. Meat analogues with good fibrous structures appeal more to consumers, because they provide a similar mouthfeel to real meat. However, this fibrous structure is difficult to replicate in a food product comprising large amounts of plant protein.

Methods of producing meat analogues include, but are not limited to: extrusion, culturing, the addition of mycoproteins, wet-spinning, electro-spinning, protein and hydrocolloid mixing, freeze-structuring and shear cell technologies.

Extrusion technology is by far the most common method by which a fibrous structure is introduced into a plant protein composition to form a “meat analogue”. Extrusion is carried out in an extruder, typically an apparatus comprising a large, rotating screw tightly fitted within a stationary barrel, the barrel terminating with a perforated die.

In the extrusion cooking process, soft mixed ingredients are forced through the barrel of an extruder where they are subjected to moisture, heat, pressure and mechanical shear force. Starch molecules within the mixture begin to gelatinise and plasticise, while proteins denature, losing their organised structure and exposing sulfhydryl bonding sites. Over a certain period of time, the food mixture becomes visco-elastic, with a homogenous, continuous phase. Laminar flow within the extruder aligns the exposed sulfhydryl bonding sites, which irreversibly cross-link proteins in the direction of flow upon cooling. Although the important bonds formed when imparting a fibrous texture to an extruded meat analogue have not been identified, it is known that covalent bonds are broken, and hydrophobic-hydrophilic interactions and disulphide bonds are formed during the process (Dekkers, 2018).

Compared with other processing methods, the high temperature, short processing time and intensive mechanical shear imparted to the mixture during extrusion cooking are three distinguishing features of this process. In general, extrusion cooking temperatures range from 100° C. to 180° C. The cooking time is typically between 30 and 150s, depending on the length of the barrel and the screw speed. The pressure in the extruder barrel ranges from 30 to 60 bars.

Generally, steam is injected into the starting food material to start the extrusion cooking process, which is aided by the friction, heat and pressure generated in the barrel. The moisture content of the food material is an important factor as moisture affects the viscosity, torque and temperature of the food material passing through the extruder.

Extruders can be categorised into single- and twin-screw extruders, according to the number of screws placed inside the same barrel. A single-screw extruder is normally applied to manufacturing low-moisture meat analogue products with a moisture content less than 35%. A twin-screw extruder is suitable for high moisture meat analogue products with a moisture content above 50%.

Following extrusion cooking, the resulting fibrous food material is cut after it emerges from the die, to give meat analogues of a particular size and shape.

While extrusion technology can be used to produce plant-based meat analogues, there are still major challenges in the development of these products. Firstly, the biggest issue is the lack of meat-like texture and flavour. Secondly, these products are generally sold in frozen form to consumers, so the textural properties and colour should not be affected by the freeze-thaw cycle. Thirdly, although many plant protein sources are cheaper than meat, meat analogues are typically higher priced than their equivalent meat products. Finally, the protein quality of plant-based meat analogues is inferior to that of real meat, as most plant proteins lack certain essential amino acids.

Many of the issues highlighted above could be alleviated by the incorporation into the plant-based meat analogue, of a small amount of meat or other animal protein. Animal protein is regarded as the premium protein source because it contains all the essential amino acids required by the human body.

The production of meat products generates a tremendous amount of edible meat by-products, which are regarded as low-value by-products. These by-products often lack consumer appeal even though they are an excellent source of highly nutritious protein, minerals and vitamins.

Therefore, the use of meat by-products in the production of plant-based food products with high consumer appeal has the potential to minimise the impact of meat consumption on the environment.

The solution that readily presents itself is to add low-cost meat by-products to the primarily plant-based ingredient mixture used to prepare meat analogues. Unfortunately, it is even more difficult to produce a fibrous texture in a hybrid (meat/plant) meat analogue than it is to texturise a simple plant-based meat analogue.

Incorporating even small amounts of meat into extrusion cooking techniques for preparing plant-based meat analogues is generally unsuccessful. The raw animal flesh tends to flood out from the extruder die and backflow into the product (Ba-Jaber, Maga, Schmidt, Sofos, 1992). Extrusion can also result in a gritty texture when chopped meat is included in the formulation ((Zarzycki, Rzedzicki, Sobota & Pawlas, 2016).

It is therefore an object of the invention to provide a process for preparing a hybrid meat analogue that overcomes at least some of the disadvantages set out above that relate to the preparation of meat analogues and/or that provides the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### 3. SUMMARY OF THE INVENTION

In one aspect the invention provides a method for producing a texturised hybrid meat analogue, the method comprising:
(a) combining at least one source of plant protein and at least one source of animal protein with water to form a protein composition with a moisture content of about 40 to about 70%,
(b) injecting high pressure steam into the protein composition in a sealed vessel while applying shear, until the protein composition reaches about 120 to about 150° C.,
(c) continuing to apply shear to the protein composition in the sealed vessel for about 5 to about 45 minutes while maintaining the temperature and moisture of the composition,
(d) allowing the protein composition to cool, to provide a texturised hybrid meat analogue.

In another aspect the invention provides a texturised hybrid meat analogue prepared by the above process.

### 4. BRIEF DESCRIPTION OF THE FIGURES

The invention will now be described by way of example only and with reference to the drawings in which:

FIG. 1 is a graphical representation of a high shear mixer: (1) electric control panel; (2) pressure indicator panel; (3), steam or cold water inlet; (4) steam or cold water outlet; (5) steam injection into vessel; (6) vessel; (7) agitator; (8) lid; (9) steam; (10) cold water.

FIG. 2 is a graphical representation of the interior of a high shear mixer: (1) jacket; (2) mixing wheel; (3) steam inlet; (4) temperature sensor.

FIG. 3 is a graph showing the changes in temperature and pressure within the high shear mixer during one embodiment of the process of the invention. At point A, the mixer, agitator and indirect steam heating are started. At point B, the direct steam injection begins. At point C, the steam injection is stopped, as is the mixer. The agitator continues to run slowly to distribute heat while the mixture cools. At point D the agitator is stopped, and the vessel unsealed to provide the texturised hybrid meat analogue of the invention.

FIG. 4 is a series of photographs of meat analogue products B, E prepared in Example 1 (photos A and B, respectively) and commercial pea-based chicken analogue (photo C).

FIG. 5 is a graph showing an example of a TPA reading to illustrate calculation of textural parameters.

FIG. 6 is a photograph of the texturised meat analogues of Example 2. From top to bottom, plant, chicken and fat samples, plant and chicken protein samples and plant-protein only sample. From left to right, standard product not processed, product undergoing water absorption and fried product.

FIG. 7 is a photograph of the texturised hybrid meat analogue of Example 2 (plant and chicken protein) prepared for cooking on a skewer.

FIG. 8 is a photograph of the textured hybrid meat analogue of Example 3, Formulation D (plant and dairy protein).

FIG. 9 is a set of photographs of hybrid meat analogues prepared using standard extrusion technology as set out in Example 4. The products shown are 95% plant protein (70:30 PPI:SPI) and 10% BT (65 CL).

FIG. 10 is a set of photographs of hybrid meat analogues prepared using standard extrusion technology as set out in Example 4. The products shown are 70% SPI and 30% BT (90 CL).

FIG. 11 is a photograph of a hybrid meat analogue prepared using standard extrusion technology as set out in Example 4. The product shown is 35% SPI, 35% PPC and 20% MPC.

FIG. 12 is a photograph of a hybrid meat analogue of the invention in the form of a large, irregularly shaped piece of material resembling a steak.

FIG. 13 is a photograph of a hybrid meat analogue of the invention in the form of a large, irregularly shaped piece of material resembling a chicken breast.

FIG. 14 is a series of graphs comparing the results of various textural analyses as described in Example 5. A=cutting force, B=hardness, C=cohesiveness, D=gumminess, E=springiness, F=chewiness, G=resilience.

### 5. DETAILED DESCRIPTION OF THE INVENTION

### 5.1 Definitions and Abbreviations

As used herein the term “comprising” means “consisting at least in part of”. When interpreting each statement in this specification that includes the term “comprising”, features other than that or those prefaced by the term may also be present. Related terms such as “comprise” and “comprises” are to be interpreted in the same manner.

The term “about” as used herein means a reasonable amount of deviation of the modified term such that the end result is not significantly changed. For example, when applied to a value, the term should be construed as including a deviation of +/−5% of the value. The term is not intended to limit any value or range of values to only this broader definition. Each value or range of values preceded by the term “about” is also intended to encompass the embodiment of the stated absolute value or range of values.

The term “meat” refers to whole or ground pieces of animal tissue with high quality protein content. The term “meat” includes prime cuts such as tenderloin, sirloin, short loin, backstrap as well as ribs, chuck, brisket, shank and the like. The term “meat” also encompasses “meat by-products” which includes boneless pieces of meat and/or offal considered less desirable than prime cuts of meat and blood products. Examples of beef by-products include boned out meat derived from fore and hindquarters, beef trimmings, skirt (meat from the diaphragm from with fat and connective tissue has been removed), head meat, cheek, muzzle, lungs, aorta etc.

The term “texturised” as used herein, with reference to a food composition, means that the food composition has been treated so as to change the globular amorphous particles of protein into substantially aligned protein fibres. Protein fibres are aligned when they are contiguous with each other at less than a 45° angle when viewed in a horizontal plane. Texturisation is best determined by visual inspection of the texturised product using the naked eye or a microscope. Protein fibres are substantially aligned when at least 50% of the fibres are contiguous with each other at less than a 45° angle when viewed in a horizontal plane.

The term “protein fibre” as used herein, refers to the individual continuous filaments or discrete elongated pieces of proteins held together by intermolecular forces such as disulfide bonds, hydrogen bonds, electrostatic bonds, hydrophobic interactions, peptide strange entanglement and Maillard reaction chemistry creating covalent links between protein side-chains. These protein fibres of varying lengths together define the structure of the hybrid meat analogue. Substantial alignment of the fibres imparts the texture of whole meat muscle to the meat analogue material.

The term “hardness” as used herein with reference to food texture, means the peak force required to compress a sample of the food to 50% of its original height in a compression test. In a compression test a probe is applied across the fibre grain of the food to compress it. In a double compression test, the food is compressed to 50% of its height then released and compressed a second time. Hardness is the peak force required in the first compression. The hardness of a given food sample may vary depending on the size and dimensions of the sample, the size of the probe and the speed of compression. A typical compression speed is 1-5 mm/s. Generally, hardness is measured with respect to small samples, eg 1-2 cm³.

The term “moisture content” as used herein, refers to the amount of moisture in a material as measured in an analytical method calculated as the percentage change in mass following evaporation of water from the material.

TABLE 1
Abbreviations

| | |
|---|---|
| BT | Beef trimmings |
| MPC | Milk protein concentrate (approx. 80% protein) |
| MPI | Milk protein isolate (approx. 90% protein) |
| PPC | Pea protein concentrate (approx. 80% protein) |
| PPI | Pea protein isolate (approx. 90% protein) |
| SPC | Soy protein concentrate (approx. 60% protein) |
| SPI | Soy protein isolate (approx. 90% protein) |
| TVP | Texturised vegetable protein |
| WCS | Waxy corn starch |
| WS | Waxy starch |
| WPC | Whey protein concentrate (approx. 80% protein) |
| WPI | Whey protein isolate (approx. 90% protein) |
| YPF | Yellow pea flour (approx. 25% protein) |

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

Whenever a range is given in the specification, for example, a temperature range, a time range, or a composition range, all intermediate ranges and subranges, as well as all individual values included in the ranges given are intended to be included in the disclosure. In the disclosure and the claims, “and/or” means additionally or alternatively. Moreover, any use of a term in the singular also encompasses plural forms.

### 5.1 the Process of the Invention

The inventors have devised a method for preparing a meat analogue which is a hybrid composition comprising both plant and animal proteins having the texture and sensory properties of meat. The hybrid meat analogue is prepared by texturizing a composition comprising plant and animal protein. The method changes globular, amorphous particles of protein into fibrous continuous phase protein material with structural integrity.

The method of the invention overcomes a number of the known challenges associated with the production of plant-based meat analogues containing animal proteins. Specifically, the invention provides a process for preparing texturised hybrid meat products which cannot be made using extrusion technology.

In one aspect the invention provides a method for producing a texturised hybrid meat analogue, the method comprising:
(a) combining at least one source of plant protein and at least one source of animal protein with water to form a protein composition with a moisture content of about 40 to about 70%,
(b) injecting high pressure steam into the protein composition in a sealed vessel while applying shear, until the protein composition reaches about 120 to about 150° C.,
(c) continuing to apply shear to the protein composition in the sealed vessel for about 5 to about 45 minutes while maintaining the temperature and moisture of the composition,
(d) allowing the protein composition to cool, to provide a texturised hybrid meat analogue.

The method of the invention is a non-extrusion method which cannot be carried out using an extrusion device.

The process of the invention involves treating a plant/animal protein composition with heat, shear and pressure for at least 5 minutes to impart a fibrous texture (or to impart at least some level or amount of fibrous structure) in the composition so as to produce a texturised hybrid meat analogue. The particular processing steps applied to the plant/animal protein composition combine to result in a texturised meat analogue with superior properties compared to comparable products made using extrusion technology.

The texturised hybrid meat analogue comprises both plant protein and animal protein. It is prepared by first combining one or more sources of plant protein and one or more sources of animal protein with water to form a protein composition.

In one aspect the invention provides a texturised hybrid meat analogue comprising a source of plant protein and a source of animal protein in a ratio of about 60:40 to about 95:5, (preferably about 70:30 to about 80:20) wherein the proteins fibres are substantially aligned.

In one embodiment, the protein composition comprises at least about 10 to about 60 wt % protein, preferably about 20 to about 50 wt % protein.

In one embodiment, the source of the plant protein is a plant protein powder. Plant protein powders include plant protein isolates, plant protein concentrates and plant protein flours.

Plant protein isolates generally comprise about 90% protein while plant protein concentrates are lower in concentration (60-80%).

Plant protein powders suitable for use in the process of the invention include, but are not limited to SPI, SPC, TVP, YPF, WCS, WS, wheat gluten, black bean protein powder, chickpea protein powder, pea protein powder, broad bean protein powder, mung bean protein powder, rice protein concentrate, potato protein, grass protein and lupin protein.

While the source of the plant protein will generally be a powdered ingredient, it may instead be a dispersion, solution, slurry or paste; for example, liquid milk, whey and the like.

In one embodiment, the protein composition comprises one or more plant protein powders selected from the group consisting of SPI, TVP, PPI, YPF, PPC, SPC, mung bean protein and wheat gluten.

In one embodiment the protein composition comprises one or more plant protein powders selected from the group consisting of SPI, PPI and PPC. In one embodiment the protein composition comprises about a 50:50 mixture of SPI and PPI.

The animal protein source for use in the process of the invention may originate from a mammal, fish, bird, insect or combination thereof. In one embodiment the animal protein source is meat. In one embodiment the animal protein source is a powdered dairy protein.

Meat suitable for use in the process of the invention includes but is not limited to whole or ground pieces of animal tissue, organ meat, mechanically separated meat, skin and other meat by-products.

In one embodiment the meat is from a livestock animal, including but not limited to, cattle, sheep, pigs, deer and goats. The meat may also be from poultry such as chicken, duck, goose or turkey.

In one embodiment the meat is selected from a beef, lamb, pork, chicken, goat or fish meat product. In one embodiment the meat is a beef product.

In one embodiment the meat is beef trimmings (BT). Beef trimmings are low value beef products comprising the trimmings from the fore and hindquarters of cattle. Beef trimmings are defined with respect to the ratio of lean meat and fat present. 65 CL BT comprises 65% lean meat and 35% fat, while 90 CL BT comprises 90% lean meat and 10% fat.

In one embodiment the meat is a chicken meat product. In one embodiment, the chicken meat product is selected from chicken mince and chicken skin.

While some fat is desirable, too much fat reduces the fibrosity of the hybrid meat analogue. Generally, a lower proportion of an animal protein source that is high in fat will be used, compared to when a low-fat animal protein source is used.

In one embodiment the protein composition comprises about 10 to about 30 wt % BT. In one embodiment the protein composition comprises about 30 wt % 90 CL BT. In one embodiment the protein composition comprises about 10 wt % 65 CL BT.

In one embodiment, the protein composition comprises one or more dairy protein powders.

Dairy protein powders suitable for use in the process of the invention include, but are not limited to MPI, MPC, WPI, WPC, sodium caseinate, calcium caseinate, whole milk powder and skim milk powder.

In one embodiment, the protein composition comprises one or more dairy protein powders selected from the group consisting of MPC, sodium caseinate and calcium caseinate.

In one embodiment the protein composition comprises a source of plant protein and a source of animal protein in a wt ratio of about 60:40 to about 95:5, preferably about 70:30 to about 80:20.

In one embodiment, the protein composition comprises one or more plant protein powders selected from the group consisting of SPI, PPI, YPF, PPC, SPC, WCS and one or more animal protein sources selected from the group consisting of BT, chicken, MPC, MPI, WPC and WPI.

In one embodiment the protein composition comprises SPI, BT and WCS.

In one embodiment the protein composition comprises about 60-90% SPI to about 10-40% BT, wherein the relative amounts of SPI and BT equal 100%.

In one embodiment the protein composition comprises about 60-70% SPI to about 30-40% BT, wherein the relative amounts of SPI and BT equal 100%.

In one embodiment the protein composition comprises about 60-80% SPI, about 10-30% BT, and about 10% WCS wherein the relative amounts of WCS, SPI and BT equal up to 100%.

In one embodiment the BT is 90 CL BT. In another embodiment the BT is 65 CL BT.

In one embodiment the protein composition comprises about 60-80% plant protein powder to about 40-20% chicken, wherein the relative amounts of plant protein powder and chicken equal 100%. In one embodiment the plant protein powder comprises SPI and PPC. In one embodiment the plant protein powder comprises about 30-50% SPI to about 50-70% PPC, wherein the relative amounts of SPI and PPC equal up to 100%. In one embodiment the protein composition comprises about 70% plant protein powder to about 30% chicken, wherein the plant protein powder comprises about 40% SPI and about 60% PPC.

In one embodiment the protein composition comprises SPI, PPC and MPC. In one embodiment the protein composition comprises about 20-45% SPI to about 20-45% PPC to about 10-40% MPC, wherein the relative amounts of SPI, PPC and MPC equal 100%.

In one embodiment the protein composition comprises about 40:40:20 SPI:PPC:MPC. In one embodiment the protein composition comprises about 35:35:20 SPI:PPC:MPC and 10% WS.

While the presence of both plant and animal protein is essential, the protein composition also comprises non-protein components.

In one embodiment the protein composition comprises one or more binding agents (for example, wheat gluten, WS, WCS, egg white, gums, hydrocolloids, polysaccharides, lecithin, enzymes and the like). In one embodiment the protein composition comprises one or more cross-linking agents (for example Konjac glucomannan (KGM) flour, beta 1,3-glucan, transglutaminase and the like). In one embodiment the protein composition comprises one or more enhancers.

The protein composition may also include starch, flour, flavourings such as yeast or meat extract, colourants, preservatives, vitamins, antioxidants, flavourings, fibre, animal or vegetable oil or fat.

In step (a) of the process of the invention, at least one source of plant protein and at least one source of animal protein are combined with water to form a protein composition.

The moisture content of the protein composition is important. If the moisture content is too high, the hybrid meat analogue product will not be very fibrous in nature. In one embodiment, the protein composition comprises between about 40 and about 70% moisture, preferably about 50 or 55 to about 65% moisture. For example, 1 kg of protein composition will comprise about 400-700 g water.

When the source of the animal protein is wet, for example, wherein the source of animal protein is beef trimmings, the moisture content is the total percentage of water present in the protein composition, including the water present in the meat. The moisture content of meat and other sources of animal protein can be calculated using the hot air oven method (A M Smith, K B Harris, A N Haneklaus, J W Savell Meat Science 2011, 89 (2): 228-32). Approximately 2 g of finely chopped sample is even spread over the base of a pre-weighed drying dish and heated at 102° C. for 16 hours. The moisture content of the meat sample is the difference between the initial and dried weights, as a percentage of the initial weight.

Similarly, if the source of the plant protein is a dispersion, solution, slurry or paste, the moisture present in the plant protein source should be accounted for, to produce a protein composition with the appropriate moisture content.

In step (b) high pressure steam is injected into the protein composition in a sealed vessel until the temperature of the composition reaches about 120 to about 150° C. At the same time, shear is continually applied to the protein composition. The rise in temperature causes the pressure within the sealed vessel to rise.

Preferably, high pressure steam is injected until the protein composition reaches about 130 to 140° C. In one embodiment the pressure in the sealed vessel reaches about 2-3 bar.

In addition to heating, the steam injection also increases the moisture content of the protein composition.

In one embodiment, prior to rapid heating by steam injection the protein composition is pre-heated to about 60 to about 80° C., preferably about 65 to about 75° C., more preferably about 70° C. The protein composition is preferably mixed during the pre-heating process, to distribute the heat evenly.

In one embodiment the method of the invention is carried out in a mixer comprising a sealable vessel that includes at least one steam inlet, wherein the mixer includes mixing apparatus capable of applying shear to the vessel contents. Mixing apparatus refers to arms, fins or other devices that protrude into the vessel interior to make contact with the protein composition. These devices apply shear to the composition, in conjunction with the walls of the vessel.

The sealable vessel is shaped so as to allow the protein composition to form a rough ball of material that is kneaded by the mixing apparatus of the mixer. The heat, shear and pressure are to be applied concurrently, in a single sealable vessel.

The method of the invention cannot be carried out in an extruder or similar device in which the protein composition is manipulated to form a tubular or elongated shape that is passed through multiple treatment zones during processing.

In one embodiment the mixer includes a heating/cooling jacket that surrounds the vessel exterior. In one embodiment the mixer applies shear to the vessel contents by way of a mixing wheel and an agitator comprising one or more arms. In one embodiment, the mixing wheel and agitator arms rotate in opposite directions. In one embodiment the mixing wheel rotates at about 50 to about 100× faster than the agitator, preferably about 80× faster.

An example of a mixer suitable for use in the method of the invention is a high shear mixer. A person skilled in the art would be able to identify other devices suitable for use in the method of the invention.

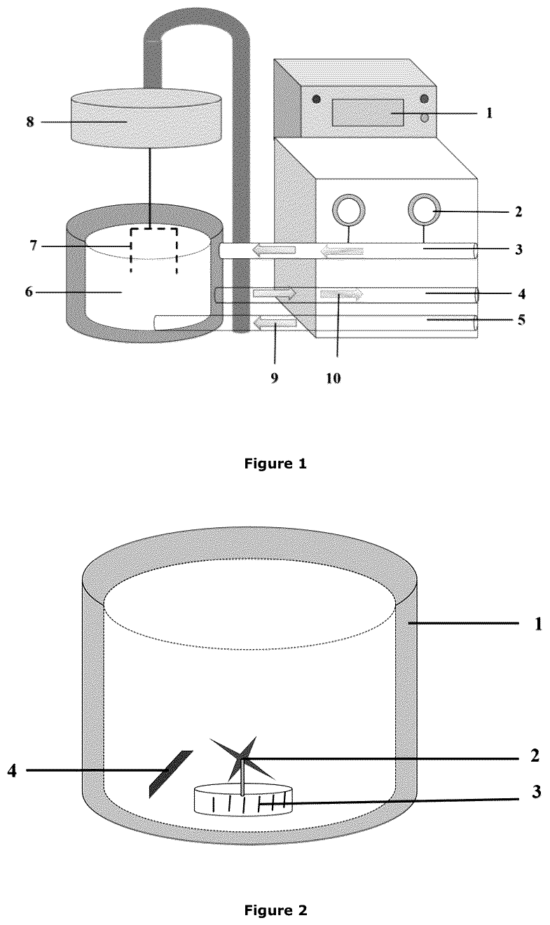

A high shear mixer is a multifunctional batch mixer and cooker used extensively in the food industry, for mixing, cooking and sterilisation. A typical mixer has a 10-L effective volume in its vessel, and the jacket of the vessel is connected to circulating steam and a cooling water source. FIG. 1 shows a graphical representation of a high shear mixer.

The processing temperature can be increased by indirect steam injection into the jacket. Cooling water allowed to circulate in the jacket can be used to decrease the temperature. Steam can also be directly injected into the vessel for rapid heating of the contents. The maximum temperature and pressure within the vessel can reach about 150° C. and 3 bar during processing.

FIG. 2 is a graphical representation of the interior of a high shear mixer. The mixing equipment comprises two parts: an agitator connected to the lid, and a high-speed mixing wheel mounted at the bottom of the vessel. The maximum mixing speed of these two mixing devices can reach up to 100 rpm and 3000 rpm, respectively, but they rotate in opposite directions, creating shear. The processing conditions can be easily monitored and controlled through the electric control panel.

In one embodiment the mixer is a Limitech™ lab mixer.

In step (c) the temperature and moisture within the sealed vessel are maintained for about 5 to about 45 minutes, while the mixer applies shear to the vessel contents. Preferably, the temperature, moisture and shear are maintained for about 5, 6, 7, 8, 9 or 10 to about 30 minutes. The protein composition within the vessel remains under pressure during this time.

While the rapid heating in step (b) is achieved by steam injection, an alternative heating method is required in step (c) so as to maintain the moisture level of the protein composition, i.e., steam cannot be introduced into the vessel during step (c). For example, the temperature of the protein composition can be maintained by indirect heating via the jacket surrounding the sealed vessel.

Mixing continues until the protein composition “melts”. “Melting” occurs when the protein in the composition undergoes thermomechanical restructuring. The input energy required for the transition comes from the steam and the mixer blades.

The input energy triggers the unfolding of the protein molecules, with a complete loss of tertiary structure and partial uncoiling of the secondary structure. At the same time, the hydrophobic and free sulfhydryl (SH) groups that were initially buried inside the native protein structure are exposed. The directional shear force being applied during thermomechanical processing in step (c) aligns the uncoiled protein molecules in the direction of the flow, resulting in a well-defined three-dimensional network structure with entrapped hydrogen molecules.

A person of skill in the art will be able to detect when the protein composition has melted from the change in the motor power (KW) of the mixing wheel. During the process of the invention, the power needed to mix the protein composition under shear conditions will gradually reduce as the viscosity changes. Once the protein composition has melted, the motor power will remain constant. The melting of the protein composition may also be observed through a viewing window, in mixing devices that include this feature. Generally, the protein composition will melt after about 5 to 45 minutes. Continued heating of the melted protein composition may lead to off-flavours and a darkening in colour.

In step (d) the heat and shear are removed and the protein composition allowed to cool to form the hybrid meat analogue of the invention.

Cooling initiates the solidification phase of structure formation in the proteins through the inter-and intramolecular aggregation of the amino acid chains.

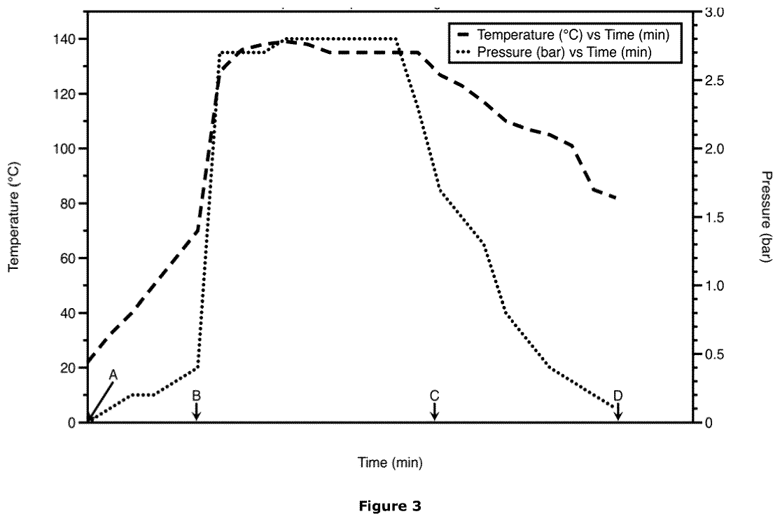

FIG. 3 shows the changes in temperature and pressure within a high shear mixer during one embodiment of the process of the invention.

The resulting plant/animal hybrid meat analogue is texturised, with the texture of animal meat.

In one aspect the invention provides a hybrid meat analogue prepared using the process of the invention.

The texture of meat or a meat analogue can be defined by a number of parameters including but not limited to the toughness, chewiness, hardness, cohesiveness, gumminess, resilience and springiness of the product.

A texture analyser with various attachments can be used to quantitatively compare meat analogues with meat samples. A V-shaped blade similar to that on a Warner-Bratzler can be used to measure cutting force and toughness while a P/51 probe can be used in a 2-bite test to validate chewiness and hardness (Chiang et al., 2019).

In one aspect the invention provides a texturised hybrid meat analogue comprising a source of plant protein and a source of animal protein in a ratio of about 60:40 to about 95:5, (preferably about 70:30 to about 80:20) wherein the proteins fibres are substantially aligned.

In one embodiment the texturised hybrid meat analogue has a hardness of at least about 15N when analysed in accordance with Example 6.

In one embodiment the texturised hybrid meat analogue has a cutting force of at least about 10N when analysed in accordance with Example 6.

In one embodiment the texturised hybrid meat analogue has a cohesiveness of less than about 0.85 when analysed in accordance with Example 6.

In one embodiment the texturised hybrid meat analogue has a gumminess of between about 8N and about 40N when analysed in accordance with Example 6.

In one embodiment the texturised hybrid meat analogue has a springiness of greater than about 0.4, preferably about 0.6 to about 0.8, when analysed in accordance with Example 6.

In one embodiment the texturised hybrid meat analogue has a chewiness of about 5N to about 35N when analysed in accordance with Example 6.

In one embodiment, the texturised hybrid meat analogue has one, two three, four, five or six of the above textural properties.

In one aspect the invention provides a textured hybrid meat analogue comprising about 60-90 SPI to about 10-40 BT, wherein the relative amounts of SPI and BT equal 100%, and wherein the hardness of the meat analogue is within up to 50% of the hardness of chicken breast when vacuum packed and boiled in water at 98° C. for 10 min.

In one embodiment the textured hybrid meat analogue comprising about 60-80% SPI to about 10-30% BT to about 10% WCS, wherein the relative amounts of WCS, SPI and BT equal 100%, and wherein the hardness of the meat analogue is within 35% of the hardness of chicken breast when vacuum packed and boiled in water at 98° C. for 10 min.

In one embodiment the textured hybrid meat analogue comprising about 10-40% chicken mince and about 60-90% plant protein, wherein the relative amounts of chicken and plant protein equal 100% and wherein the plant protein comprises about 30-50% SPI and 50-70% PPC, wherein the relative amounts of SPI and PPC equal 100, and wherein the hardness of the meat analogue is within 10% of the hardness of chicken breast when pan fried.

In one aspect the invention provides a textured hybrid meat analogue comprising about 20-45% SPI to about 20-45% PPC to about 10-40% MPC, wherein the relative amounts of SPI, PPC and MPC equal 100%, and wherein the hardness of the meat analogue is within up to 50% of the hardness of chicken breast when vacuum packed and cooked in water until reaching an internal temperature of 75-80° C.

In one embodiment the texturised hybrid meat analogue comprises large, irregularly shaped pieces of material with the texture of meat. In one embodiment, the large, irregularly shaped pieces of material are at least 10, 12, 14, 16, 18 or 20 cm long and at least 6, 8, 10, 12, 14, 16, 18 or 30 cm wide.

Embodiments of the invention will now be illustrated with reference to examples.

### 6. EXAMPLES

### Example 1: Textured Hybrid Meat Analogues Comprising Beef Trimmings

### Materials

SPI (Pro-fain 974, Archer Daniels Midland Co., USA), and 90 CL Beef (ANZCO Foods Limited, New Zealand) were kept in a freezer (−18°c) prior to use. WCS (National Starch and Chemical Company, New Zealand), comprising nearly 1000/amylopectin, was used as a fibrous structure enhancer. YPF (Davis Trading, New Zealand) was mixed with SPI for the preliminary experiment, as the former has a similar protein content to 90 CL beef.

TABLE 2
The proximate composition of raw materials used

| | Percentage (%) | | | |
|---|---|---|---|---|
| Materials | Moisture | Fat | Protein | Ash |
| YPF | 4.36 ± 0.03 | 6.7 ± 0.04 | 22.4 ± 0.29 | 5.67 ± 0.07 |
| SPI | 5.83 ± 0.03 | 4.02 ± 0.05 | 88.97 ± 0.48 | 5.31 ± 0.05 |
| 90 CL BT | 63.92 ± 0.05 | 16.34 ± 0.09 | 18.45 ± 0.19 | 1.24 ± 0.08 |
| WCS | 4.55 ± 0.02 | 0.35 ± 0.01 | 0.11 ± 0.01 | 0.75 ± 0.01 |

Data is displayed as means (n = 3) ± standard deviation

90 CL BT (90 Chemical Lean CL) is a low value beef product comprising trimmings from the fore and hindquarters of cattle. It consists of 900/lean read meat and 10%/fat.

Experiments were conducted with four different ratios of SPI-BT blends (100/0, 70/30, 60/40 and 50/50) as set out in Table 3. In addition, another formulation containing WCS as a binder was prepared. Feed moisture was kept consistent at 50%/.

TABLE 3
Formulations of raw materials processed

| | Ingredients (g/100 g feed materials) | | |
|---|---|---|---|
| Sample ID | SPI | 90 CL BT | WCS |
| Product A | 100 | 0 | 0 |
| Product B | 70 | 30 | 0 |
| Product C | 60 | 40 | 0 |
| Product D | 50 | 50 | 0 |
| Product E | 60 | 30 | 10 |

### The Process:

The 90 CL BT was cut into small blocks and finely ground with a meat grinder (HL-G12, Dynasty, Taiwan). For each experiment, 2000 g of raw material was prepared according to the ratio described in Table 3. The protein composition was blended using a planetary mixer (ARM-02, Thunderbird, Canada) for 10 min to ensure uniformity. Reverse osmosis (RO) water was added in the mixture for pre-humidification. Finally, around 4000 g of the protein dough with 50% moisture was filled into the vessel of the high shear mixer, ready for processing. Three replicates of each formulation were processed in the high shear mixer.

Compared with extrusion cooking, the process of the invention requires longer cooking time to achieve complete protein unfolding and cross-linking. The process can be divided into four stages. The changes in temperature and pressure during processing are shown in FIG. 3.

Stage 1: After feeding the blended protein composition into the vessel, steam was injected into the jacket of the high shear mixer to pre-heat the samples to 70° C. The rotation rates of the agitator and the bottom mixing wheel were controlled at 50 rpm and 1500 rpm, respectively, to achieve comprehensive heating and uniformity of the materials.

Stage 2: Once the temperature reached 70° C., steam was injected into the vessel for 10 min for heating. During this period, the temperature and pressure increased sharply, reaching the maximum temperature and pressure of approximately 140° C. and 3 bar, respectively. The rotation rate of the agitator and mixing wheel were kept at a constant rate of 50 rpm and 1000 rpm, respectively. The injection of steam led to a decrease in the speed of the mixing wheel at the bottom.

Stage 3: To prevent extensive moisture in the final products while maintaining the processing temperature at ˜140° C., the steam was switched to being injected into the jacket of the vessel for 10 min. The rotation rate of the agitator and mixing wheel were kept consistent with the conditions in Stage 2.

Stage 4: After thermomechanical processing for 20 min at 140° C., the cooling system was opened for the release of pressure inside the vessel. The rotation rate of the agitator decreased to 20 rpm and the mixing wheel was stopped, to avoid destruction of the fibrous structure. The cooling water was allowed to circulate in the jacket, resulting in the pressure decreasing immediately to 0 bar. Subsequently, the lid could be opened with no pressure inside the vessel, which occurred when the inside of temperature dropped to −90° C. The texturised hybrid meat analogue was collected and vacuum-packaged (C-200, Multivac, Germany) in plastic bags. All the samples were stored in a freezer (−20° C.). The products were defrosted in a chiller for around 24 h prior to further analysis.

### Analysis of Hybrid Meat Analogue

Moisture analysis, crude fat, protein and ash content, pH, colour, microstructural and ultrastructural analysis (SEM and TEM) were all carried out on the texturised hybrid meat analogues prepared.

Table 4 shows the results of a proximate analysis of a commercial soy-based meat analogue and commercial ground beef patties, according to the study of Hegarty & Ahn, (1976). In addition, Table 4 shows the results of proximate analysis of the five hybrid meat analogues (A to E) prepared in accordance with the process of the invention.

TABLE 4
Proximate composition of a commercial meat analogue,
ground beef patties and Products A to E

| Product | Moisture (%) | Protein (%) | Fat (%) | Ash (%) |
|---|---|---|---|---|
| A: 100% SPI | 61.79 ± 0.70^{a3} | 35.07 ± 0.13^{a} | 0.49 ± 0.04^{e} | 1.45 ± 0.04^{a} |
| B: 70% SPI + | 61.80 ± 0.76^{a} | 34.87 ± 0.69^{ab} | 2.13 ± 0.03^{d} | 1.50 ± 0.03^{a} |
| 30% BT | | | | |
| C: 60% SPI + | 62.75 ± 1.91^{a} | 33.10 ± 0.17^{bc} | 3.97 ± 0.09^{b} | 1.44 ± 0.05^{a} |
| 40% BT | | | | |
| D: 50% SPI + | 61.50 ± 0.69^{a} | 32.31 ± 0.11^{c} | 4.80 ± 0.16^{a} | 1.24 ± 0.05^{b} |
| 50% BT | | | | |
| E: 60% SPI + | 62.14 ± 0.98^{a} | 28.12 ± 0.03^{d} | 1.43 ± 0.08^{c} | 1.49 ± 0.07^{a} |
| 30% BT + | | | | |
| 10% WCS | | | | |
| Commercial plant- | 69.87 | 20.30 | 2.93 | 2.34 |
| based meat | | | | |
| analogue¹ | | | | |
| Commercial ground | 68.05 | 19.90 | 12.32 | 1.75 |
| beef patties^{1, 2} | | | | |

¹Hegarth and Ahn (1976).
²Samples were heated on an electronic pan at temperature of 177° C. until the internal temperature was 70° C.
³Different letters in the same column represent a significant difference (p < 0.05). Results are expressed as means (n = 3) ± standard deviation with Tukey's pairwise comparisons.

In comparison with the commercial soy-based meat analogue and the beef patties, the texturised meat analogues of the invention obtained were higher in nutrient density, especially with respect to protein.

### Textural Analysis

The texturised meat analogues A to E were compared to control products F and G. Product F is a commercial pea-based chicken analogue. Product G is cooked chicken breast that was vacuum packaged and boiled in water at ˜98° C. for 10 min.

All of the products were thawed at 4° C. for ˜24 h, then cut into rectangular shapes before textural analysis. All analyses were performed at room temperature and measured with a texture analyser (TA XT. Plus, United Kingdom), with a load cell of 5.0 kg in the following tests. The textural results were analysed with Texture Exponent software version 6.1.15.0 (Stable Microsystems Ltd., England). The analysis of product texture was performed as described by Paula & Conti-Silva (2014).

Hardness analysis: Small samples measuring 1×1×1 cm (length×width×height) were compressed across the fibre grain with a cylindrical probe (3.5 cm in diameter) to 50% of its original height at a test speed of 1.00 mm/s, a pre-test speed of 0.5 mm/s and a post-test speed of 2.00 mm/s. At least 10 replications were performed on each sample. The hardness was the peak force experienced during the compression.

The hardness of the products is reported in Table 5.

TABLE 5
Hardness of meat analogue of the invention compared to
cooked chicken breast and a commercial meat analogue.

| | Hardness (N) |
|---|---|
| A | 50.47 ± 0.54^{a} |
| B | 42.20 ± 1.08^{b} |
| C | 30.39 ± 0.90^{c} |
| D | 27.87 ± 1.01^{d} |
| E | 29.18 ± 0.64^{c} |
| F | 40.57 ± 0.44^{b} |
| G | 18.68 ± 0.60^{e} |

Different letters in the same column indicate significant differences (p < 0.05) according to Tukey comparisons. Results are expressed as means (n ≥ 10) ± standard deviation.

It can be seen from Table 5 that the protein composition had a significant (p<0.05) effect on the texture of the products. The hardness of the product decreased with an increase in the proportion of BT in the formulation (indicating that the addition of meat led to product softness.

The hybrid meat analogues of the invention (Products B to E) were closer in hardness to the control chicken breast (H=18.68 N) than was a comparable meat analogue comprised of only plant proteins (Product A, H=50.47 N). Many of the hybrid meat analogues of the invention (Products C, D and E) were closer in hardness to cooked chicken breast that the commercially available pea-based chicken analogue (Product F).

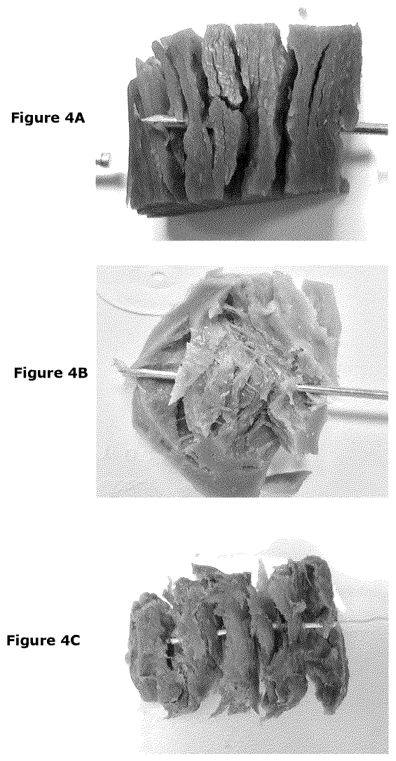

Photographs of hybrid meat analogues of the invention (Products D and E) are shown in FIG. 4, along with a commercial pea-based meat analogue (Product F).

### Example 2: Textured Meat Analogues Comprising Chicken

### Materials

SPI, PPC, YPF and WCS were purchased from Davis Trading (Palmerston North, New Zealand). A commercial variety of meat analogue pea-protein based chicken analogue and minced chicken breast were purchased from New World supermarket in Palmerston North. All chemicals and reagents used in this study were of analytical grade. Chicken fat was derived from the low value waste stream of chicken skin, sourced from Turks Poultry Farm, Levin, New Zealand (35.1% fat and 49.4% moisture (FSANZ, 2019)).

Three protein compositions were prepared for processing: A: Plant protein only (40% SPI and 60% PPC) B: Plant and chicken protein hybrid (70% plant proteins (comprising 40% SPI and 60% PPC) and 30% chicken mince) C: Plant and chicken protein with additional fat hybrid (65% plant proteins (comprising 40% SPI and 60% PPC), 25% chicken mince and 5% additional chicken skin fat) The process: The powdered plant protein source and chicken material (where appropriate) were mixed with water, to give a 50% moisture protein dough. The chicken material was processed to a thin paste prior to use. In each trial, a 4 kg batch of protein dough was processed as set out in Example 1. Once the sealed vessel had cooled sufficiently, the texturised meat analogue was removed, vacuum sealed into FAT pouches and frozen for later analysis.

Textural analysis: All tests were undertaken on the TA.XT Plus, Stable Micro Systems, UK provided by Massey University. Attachments required vary depending on the following tests performed. To mitigate differences between samples, nine repeats of the tests were performed.

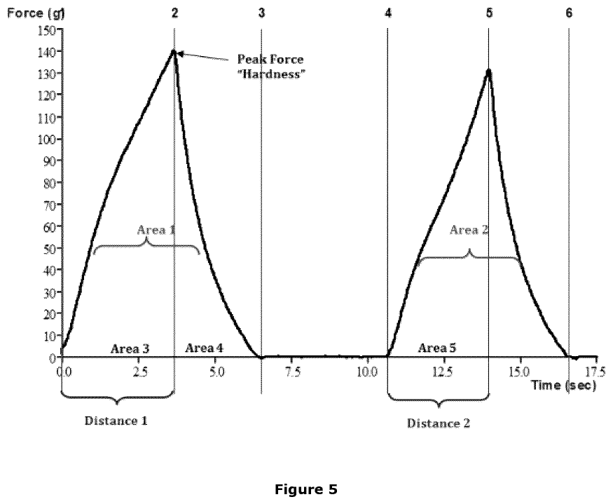

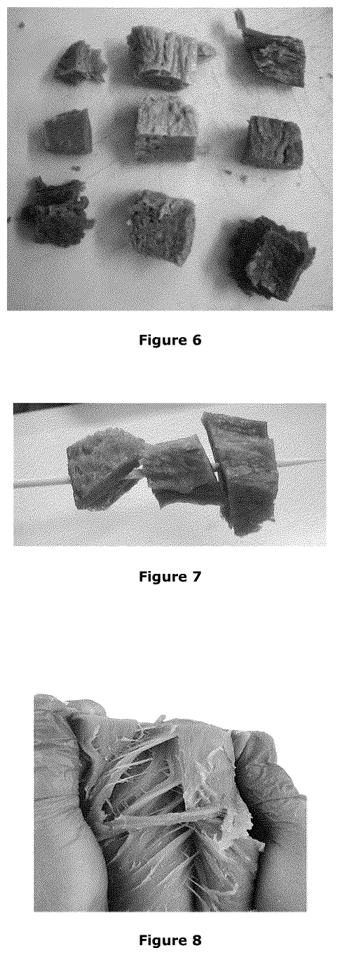

Hardness analysis: The hardness of the meat analogues was analysed using a Texture Profile Analysis (TPA) or “Two-Bite Test”. This test assimilates the textural characteristics of the samples at the beginning of mastication, as illustrated in FIG. 5. Hardness is defined as the peak force required to compress the sample by 50% in the first compression.

The sample was cut into a square shape (20 mm×20 mm×20 mm) and compressed using a P/61 probe to 50% of its original shape. The first compression occurred at a speed of 1.00 mm/s until the sample was compressed by 50%, then returned to the pre-test position over 5 seconds. The second compression occurred at a speed of 1.00 mm/s to 50% of the first compressed shape. The sample was placed so that the fibres ran perpendicular to the probe (horizontal). The test was performed at a trigger force of 0.049 N and each sample was repeated in triplicate. One test was performed per one sample. Pan fried chicken breast was used as a control, along with a commercially available pea protein-based chicken analogue.

Further data analysis regarding the significance of difference between results was performed on Minitab using Anova and Tukey HSD tests.

TABLE 6
Results of Hardness Analysis

| Sample | Hardness (g) |
|---|---|
| Chicken breast | 62 ± 8 |
| Plant-based commercial | 133.2 ± 0.2 |
| chicken analogue product | |
| SPI and PPC | 37 ± 6 |
| SPI, PPC and chicken | 67 ± 3 |
| SPI, PPC, chicken and fat | 64 ± 5 |

### Example 3: Textured Meat Analogues Comprising Dairy Proteins

### Materials

Pea protein concentrate (80% protein), soy protein isolates (protein 85%) were bought from Davis trading Co. New Zealand. Milk protein concentrate (protein 85%) was obtained from Fonterra, New Zealand. Five formulations were prepared in accordance with Table 7.

TABLE 7
Formulations comprising dairy protein

| Formulation | Ingredients |
|---|---|
| A | 45% SPI, 44% PPC, 10% WS |
| B | 40% SPI, 40% PPC, 10% WS, 10% MPC |
| C | 35% SPI, 35% PPC, 10% WS, 20% MPC |
| D | 30% SPI, 30% PPC, 10% WS, 30% MPC |
| E | 25% SPI, 25% PPC, 10% WS, 40% MPC |

### The Process:

Texturised hybrid meat analogues were prepared from the five formulations using the process set out in Example 1. The process included premixing the ingredients with up to 50% moisture in a Thunderbird mixer for 30 min. The moist granules of the feed mixture were then transferred to the shear mixer for further processing. The finished samples were stored in the sealed bag and placed inside a freezer at −18° C. All five products showed a layered, fibre-like structure.

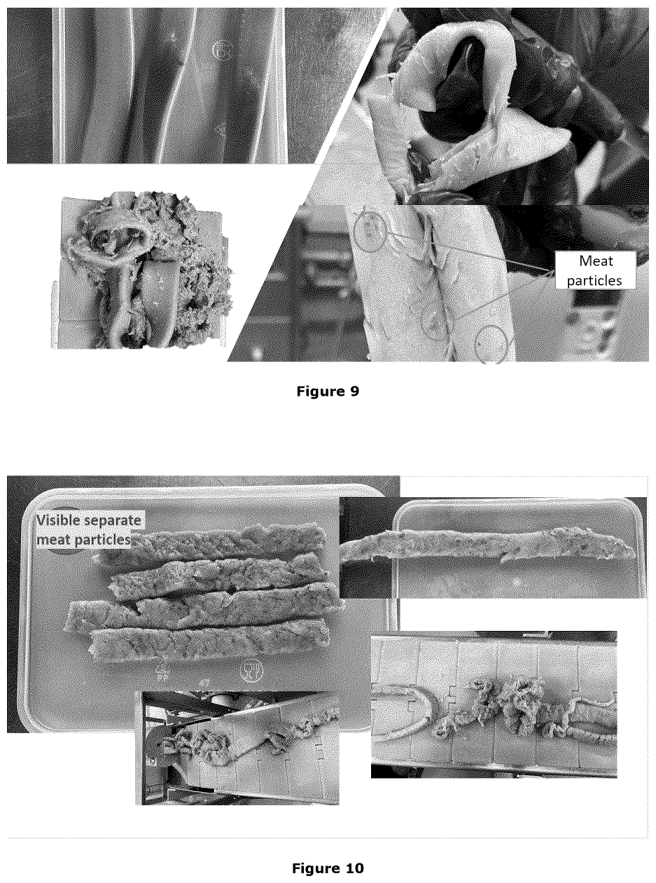

All five products showed a layered, fibre-like structure, as exemplified by the hybrid meat analogue prepared from Formulation D, shown in FIG. 9.

Hardness analysis: The hardness analysis was carried out on each of the five samples using a TA-XTplus Texture Analyser (Stable Micro Systems, UK). The hardness analysis was conducted by a double compression test using a cylindrical probe P/51 (51 mm cylinder), by applying 50 kg pre-load, test speed of 5 mm/sec and trigger force of 0.49 N for 50% compression ratio during the first compression on a sample of 15×15×15 mm dimensions (Das, Anjaneyulu, Gadekar, Singh, & Pragati, 2008). An average of 5 repetitions was recorded along with the standard deviation using Microsoft Excel. Control meets (cooked chicken breasts, lamb, pork, and lamb) were prepared according to Chiang et al. (2019) with modifications. Chicken breasts were individually vacuum packaged in plastic bags and cooked in a heated water bath. The meats were cooked to an internal temperature of 75-80° C., removed from the water bath and cooled at room temperature for 30 min, drained and sectioned for hardness analysis to ensure uniform sampling temperature. The results of the hardness analysis are set out in Table 8.

The structural and textural characteristics of plant protein mixture (Formulation A) and plant-dairy protein Formulations B, C, D, E) mixture, are given in Table 8. The addition of MPC (from 10-40%) significantly impacted the fibrous structure in the hybrid meat analogues. The addition of 20% MPC (Formulation C) offered a well-aligned fibrous structure. Overall, both Formulations B and C displayed textural characteristics very similar to that of chicken breast. However, Formulation C had a higher hardness value which was close to cooked chicken breast.

TABLE 8
Results of the moisture, protein, hardness analysis

| Formulation | Moisture (%) | Protein¹ (%) | Hardness (N) |
|---|---|---|---|
| 45% SPI | 70.39 ± 0.07 | 24.01 | 30.25 ± 5.08 |
| 45% PPC | | | |
| 10% WCS | | | |
| 40% SPI | 70.63 ± 0.12 | 24.17 | 15.69 ± 2.74 |
| 40% PPC | | | |
| 10% WCS | | | |
| 10% MPC | | | |
| 35% SPI | 69.81 ± 0.25 | 24.34 | 27.51 ± 5.83 |
| 35% PPC | | | |
| 10% WCS | | | |
| 20% MPC | | | |
| 30% SPI | 71.14 ± 0.32 | 24.51 | 28.16 ± 5.20 |
| 30% PPC | | | |
| 10% WCS | | | |
| 30% MPC | | | |
| 25% SPI | 69.52 ± 0.16 | 24.68 | 30.59 ± 4.00 |
| 25% PPC | | | |
| 10% WCS | | | |
| 40% MPC | | | |
| Chicken Breast² | 63.06 ± 0.18 | 25.99 | 27.34 ± 5.90 |
| Commercial³ | 48.31 ± 1.10 | 36.10 | 41.22 ± 4.60 |
| Pork | — | — | 73.95 ± 3.56 |
| Beef | — | — | 51.04 ± 7.83 |
| lamb | — | — | 21.88 ± 3.99 |

¹Calculated values based on a mass balance equation;
²Chicken breast was vacuum packed and cooked sous vide at 98° C. for 20 min;
³Data available on the packaging of the commercial sample (aside from moisture content).

### Example 4: Comparison with Hybrid Meat Analogues Prepared Using High-Moisture Extrusion Cooking

Four hybrid meat analogue products were prepared as set out below:
A: 95% plant proteins (70:30 PPI:SPI)+5% beef fat
B: 95% plant proteins (70:30 PPI:SPI)+10% beef (65CL beef trimmings)
C: 70% SPI+30% beef (90CL beef trimmings)
D: 35% SPI+35% PPC+10% Wheat starch+20% Milk Protein Concentrate

The nutritional content of the meat by-products used is set out in Table H.

TABLE 9
Nutritional content of 90 CL and 65 CL

| | Moisture (%) | Protein (%) | Fat (%) | Ash (%) | pH |
|---|---|---|---|---|---|
| 90 CL | 63.92 ± 0.05 | 18.45 ± 0.19 | 16.34 ± 0.09 | 1.24 ± 0.08 | — |
| 65 CL | 44.30 ± 0.48 | 42.41 ± 1.64 | — | 0.49 ± 0.00 | 5.64 ± 0.01 |

Formulations A-D were prepared and pre-mixed using a classic extrusion cooking method, as outlined below.

The 90 or 65 CL beef trim was cut into small blocks and finely ground with a meat grinder (HL-G12, Dynasty, Taiwan). For each experiment, 2000 g of raw material was prepared according to the ratio described in the formulations above. The protein composition was blended using a planetary mixer (ARM-02, Thunderbird, Canada) to ensure uniformity. Reverse osmosis (RO) water was added in the mixture for pre-humidification. Finally, around 4000 g of the protein dough with 50% moisture was filled into the vessel of the high shear mixer, ready for processing.

### Extrusion Cooking:

The extrusion cooking experiments were conducted using a pilot plant-scale, co-rotating, and intermeshing twin-screw extruder (Clextral BC-21; Firminy Cedex, France) using the method described by Chiang, Loveday, Hardacre & Parker (2019). The operating parameters were set as follows: screw diameter (Ds), 25 mm; total screw length (Ls), 700 mm; length/diameter ratio of screw (Ls/Ds), 28:1; barrel diameter (Db), 26 mm; and a long cylindrical cooling die with diameter of 10/355 mm was attached at the end of the extruder. The screw profile comprised (from feed to exit) of: two 50 mm length, 20 mm pitch, forward screw (100 mm); three 50 mm length, 15 mm pitch, forward screw (150 mm); two 50 mm, 10 mm pitch, forward screw (100 mm); one 50 mm, 15 mm pitch, forward screw (50 mm), one 25 mm, 7 mm pitch, reverse screw (25 mm); one 50 mm, 15 mm pitch, forward screw (50 mm), one 25 mm, 7 mm pitch, forward screw (25 mm); and four 50 mm, 7 mm pitch, forward screw (200 mm). The barrel was segmented into the feeding zone (T1) and six temperature-controlled zones (T2 to T7), which was heated by steam and cooled by running water pipes (−25° C.). A gravimetric feeder (K-ML-D5-KT20 and LWF D5, Coperion K-Tron, Switzerland) was used to feed the dry ingredients into the extruder at a rate of 2.4 kg/h. Water was injected into the extruder through an inlet port at a constant flow of 3.6 kg/h to obtain the moisture content of approximately 60% w/w (wet basis) in the final product. The screw speed was 400 rpm and the barrel temperatures were set at 20, 50, 80, 110, 150, 170 and 150° C. in the seven zones from feed to die.

Table 10 sets out the results of the analysis carried on Formulations A-C

TABLE 10
Analysis of Formulations A-C

| | Colour measurement | | | Moisture |
|---|---|---|---|---|
| Formulation | L* | a* | b* | content (%) |
| A | 53.46 ± 0.92 | 2.60 ± 0.14 | 16.48 ± 0.87 | 59.21 ± 0.71 |
| B | 52.05 ± 1.61 | 2.45 ± 0.35 | 16.47 ± 0.69 | 59.19 ± 0.59 |
| C | 48.96 ± 0.42 | 3.55 ± 0.11 | 12.58 ± 0.45 | 63.98 ± 0.24 |

### Results

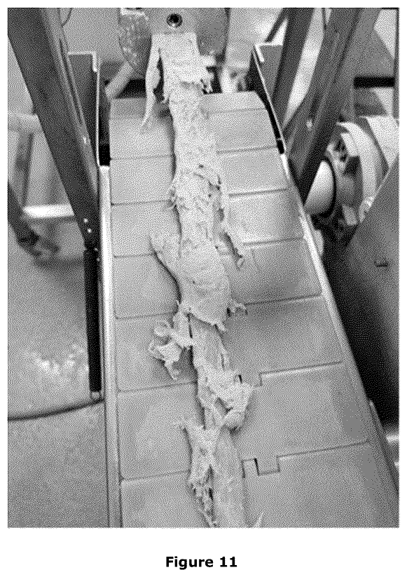

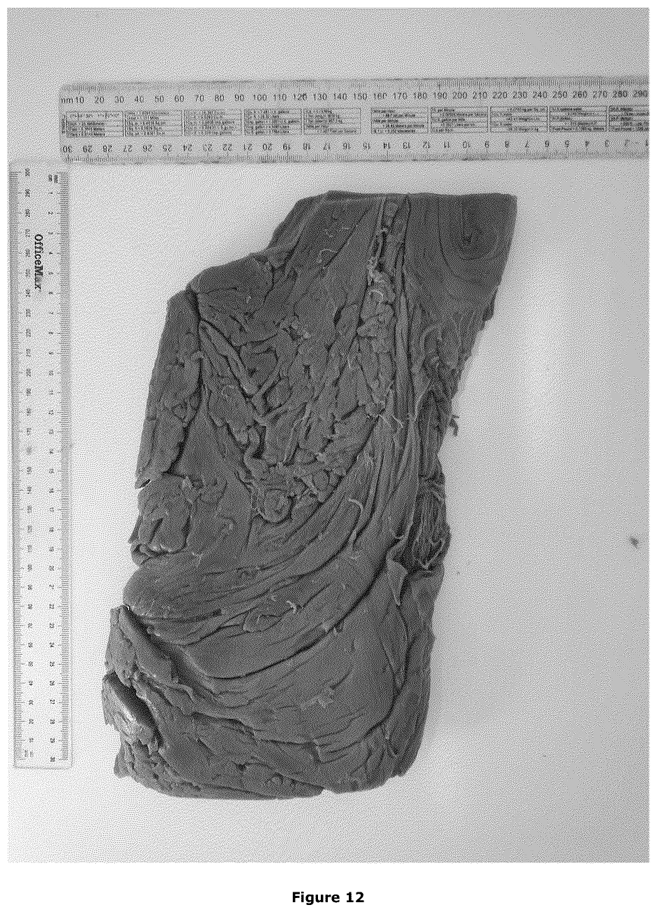

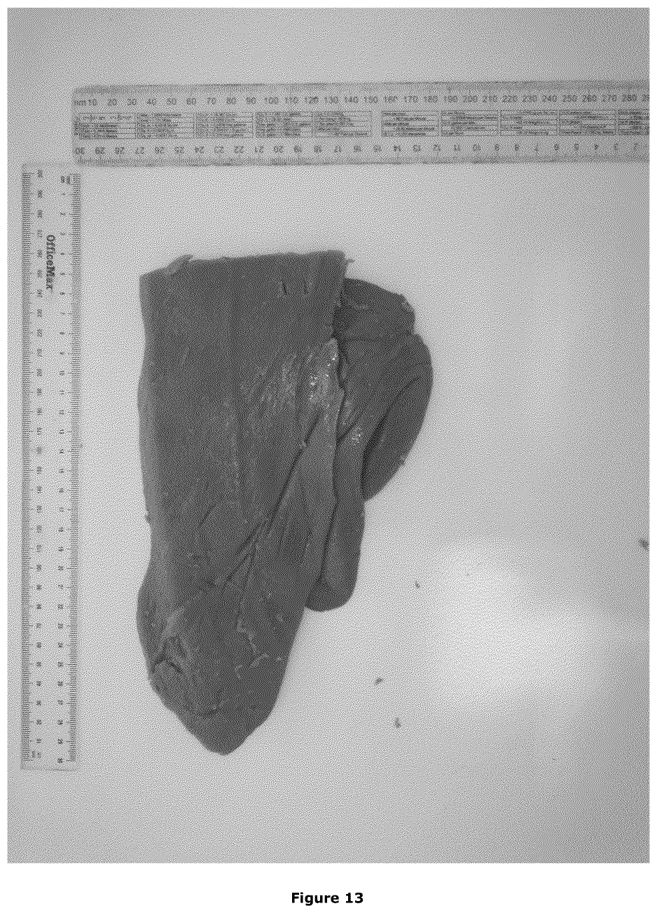

The plant proteins and meat could not be mixed evenly and meat particles were clearly visible in the extruded product, because of the short processing time during extrusion. This can be seen in FIGS. 9 and 10.

The addition of dairy protein (MPC at 20% concentration) resulted in phase separation and poor extrudability, as seen in FIG. 11.

### Example 5: Textured Meat Analogues Comprising Beef Trimmings

### Materials

Pea Protein Isolate (PPI) (3700/11129190002) was purchased from Davis Food Ingredients, New Zealand and Soy Protein Isolate (SPI) (PROFAM 974) was purchased from Archer Daniels Midland Company, USA. About 50CL and 65CL beef trimmings were supplied in a refrigerated container by Affco Manawatu (Fielding, New Zealand). The proximate composition of the protein isolates is shown in Table 11.

TABLE 11
Proximate composition of protein isolates (wt %)

| Protein | Moisture | Protein | Fat | Ash | pH |
|---|---|---|---|---|---|
| PPI | 7.41 ± 0.02^{a} | 76.01 ± 0.45^{b} | 0.34¹ | 8.09 ± 0.76^{a} | 6.54 ± 0.02^{b} |
| SPI | 5.76 ± 0.26^{b} | 85.61 ± 0.22^{a} | 0.30² | 4.28 ± 0.30^{b} | 7.10 ± 0.02^{a} |

Data are presented as means (n = 3) ± standard deviation. Values with different letters in the same column are significantly different (p < 0.05).

### Methods

### Meat Paste Preparation

Beef trimmings (50CL and 65CL) were cut into smaller dimensions using a sharp knife, then minced in the pilot plant using a Mainca Mincer (PM-98, Spain), through a plate of 8 mm diameter. The trimmings were then transferred into a Talsa Bowl Chopper (C-35 STP, New Zealand) with a knife and bowl speed of 1420 rpm and 690 rpm, respectively, until a uniform paste was obtained (approximately 2 min). The paste was portioned into polyethylene bags and vacuum sealed at a pressure of 2.3 MPa, then frozen at −20° C. until further use.

### The Process:

The source of plant protein and source of animal protein were mixed with water to produce a protein composition with a moisture content of about 40 of about 45 wt % and placed in a high shear mixer comprising a double jacketed vessel of 10 L maximum capacity, having direct and indirect steam and water inlets and outlets, an agitator (which comprises small blades connected to the motor) rotates from the base of the cooker) and a mixer (larger blades suspending from the lid) that provides shear during processing.

Once the raw materials were transferred into the vessel, the lid was closed and the vessel sealed to avoid steam and temperature loss. Indirect steam was used to preheat the contents to 70° C. at 0.3 bar. The mixer and agitator speeds were set to 50%, which yielded 21.5 rpm for the agitator and 1734.2 rpm for the mixer. Once 70° C. was attained, direct steam was introduced to the vessel contents, and the temperature and pressure were maintained at 140° C. and 3 bar, respectively for 25 minutes, until a fibrous structure was observed. At that point, the steam, agitator and mixer were turned off, and the vessel contents cooled. The samples were collected and vacuum packaged using a vacuum sealer (C-200, Multivac, Germany) at 2.3 MPa to avoid moisture loss and stored at −18° C. for later analysis.

Besides the commercial sample, four plant protein/meat analogues containing beef trimmings were produced (B5, 5% 50 CL beef trimmings, 95% plant protein; B10, 10% 50 CL beef trimmings, 90% plant protein; C5, 5% 65 CL beef trimmings, 95% plant protein; C10, 10% 65 CL beef trimmings, 90% plant protein) and beef trimmings were added to sum up to the total dry ingredient basis. The control was 70% SPI and 30% PPI.

### Textural Analysis:

Six textural properties of the hybrid meat products were analysed, using standard techniques, as described above. Hardness, chewiness, cohesiveness and cutting force of meat analogues were significantly decreased compared to control. For springiness, there was no significant difference between all of the meat analogue samples produced. The values obtained for chewiness in the control sample were not significantly different (p >0.05) to chicken breast (sample D) but were significantly different to the commercial sample (sample E). Furthermore, C5 also had a chewiness score closer to chicken breast than to the commercial sample, but samples B5, B10, C10 and commercial meat analogue were not significantly different from one another but significantly different to other meat analogue samples. No significant difference was noticed when testing for resilience for all formulated and reference samples.

The cutting force of all samples was carried out using Warner-Bratzler method. The commercial sample needed the highest force to cut through the fibre orientation, followed by chicken breast and the control sample. But the values for commercial and control samples were not significantly different from that of chicken breast. Hybrid meat analogues of the invention were also not significantly different from each other. They however required lower forces to cut through fibre orientation when compared to the control, chicken breast and commercial samples.

Conclusively, for most of the textural properties studied, the control sample was closest to chicken breast and beef trimmings had a significant effect on meat analogues. The addition of 50 CL and 65 CL reduced the hardness, chewiness resilience and cutting force of the hybrid meat analogues compared to the control sample. The resilience and cohesiveness of the hybrid meat analogues were similar to that of chicken breast and control sample, with sample C10 having the same values as chicken breast.

TABLE 12
Texture Properties of meat analogues in Comparison to cooked chicken
breast and thighs, beef cheeks and a Commercial plant-based product

| | Texture Profile Analysis | | | | | Cutting |
|---|---|---|---|---|---|---|
| | | Cohesiveness | Springiness | Chewiness | Resilience | Force |
| | Hardness (N) | (ratio) | (ratio) | (N) | (ratio) | (N) |
| Control¹ | 56.49 ± 8.38^{b} | 0.66 ± 0.12^{a} | 0.77 ± 0.05^{ab} | 29.04 ± 5.33^{a} | 0.29 ± 0.07^{a} | 18.27 ± 0.16^{b} |
| B5¹ | 38.81 ± 3.77^{bc} | 0.57 ± 0.06^{a} | 0.77 ± 0.10^{ab} | 14.71 ± 4.44^{b} | 0.22 ± 0.05^{a} | 11.96 ± 2.03^{c} |
| B10¹ | 27.38 ± 3.96^{c} | 0.53 ± 0.10^{a} | 0.78 ± 0.07^{a} | 10.82 ± 4.49^{b} | 0.22 ± 0.04^{a} | 7.36 ± 1.66^{c} |
| C5¹ | 50.69 ± 9.97^{b} | 0.62 ± 0.04^{a} | 0.84 ± 0.02^{a} | 23.54 ± 9.31^{ab} | 0.27 ± 0.02^{a} | 10.92 ± 4.95^{c} |
| C10¹ | 42.88 ± 7.90^{bc} | 0.49 ± 0.01a | 0.75 ± 0.04^{ab} | 12.73 ± 3.53^{b} | 0.20 ± 0.02^{a} | 10.23 ± 5.44^{c} |
| D^{1,2} | 103.46 ± 8.29^{a} | 0.59 ± 0.01^{a} | 0.63 ± 0.03^{bc} | 33.47 ± 2.87^{a} | 0.20 ± 0.00^{a} | 22.34 ± 0.86^{ab} |
| E³ | 41.22 ± 4.60^{bc} | 0.51 ± 0.06^{a} | 0.56 ± 0.02^{c} | 10.07 ± 1.53^{b} | 0.19 ± 0.03^{a} | 26.93 ± 1.97^{a} |
| CT⁴ | 25.88 ± 6.34 | 0.59 ± 0.04 | 0.60 ± 0.06 | 7.75 ± 1.20 | 0.23 ± 0.02 | 15.52 ± 0.39 |
| BC24⁴ | 35.90 ± 2.07 | 0.56 ± 0.02 | 0.59 ± 0.08 | 10.44 ± 2.59 | 1.84 ± 0.46 | 32.92 ± 14.25 |
| BC48⁴ | 37.21 ± 5.63 | 0.51 ± 0.09 | 0.64 ± 0.25 | 11.58 ± 7.73 | 2.59 ± 1.25 | 26.30 ± 8.60 |

B5, 5% 50 CL beef trimmings 95% plant protein; B10, 10% 50 CL beef trimmings 90% plant protein; C5, 5% 65 CL beef trimmings 95% plant protein; C10, 10% 65CL beef trimmings 90% plant protein; D, chicken breast; E, commercial plant-based sample; CT, chicken thigh; BC24, beef cheeks cooked for 24 hr; BC48, beef cheeks cooked for 48 hr. Data are presented as means (n = 3) + standard deviation. Values with different uppercase letters in the same column are significantly different (p < 0.05).
¹Sample's dimension was 20 mm × 20 mm × 20 mm for texture profile analysis.
²Chicken breast was vacuum packed and boiled at 98° C. for 20 min.
³Sample dimensions was 20 mm × 20 mm × 15 mm mm (l × b × h), as a result of the product's format.
⁴Samples dimensions were 15 mm × 15 mm × 15 mm for texture profile analysis, as a result of the product's format.

### Example 6: Comparison of Hybrid Meat Products with Genuine Meat Products

Three hybrid meat products of the invention were prepared according to the process outlined above—(A) plant and beef hybrid, (B) plant and chicken hybrid and (C) plant and dairy hybrid. Product (A) was prepared in accordance with Example 1, using 70% SPI and 30% beef mince. Product (B) was prepared in accordance with Example 3, using 70% SPI and 30% chicken mince. Product (C) was prepared in accordance with Example 4 using 35% PPC, 35% SPI, 20% MPC and 10% WS.

Three plant-based control products were also prepared using the process of the invention. The protein sources for the three plant-based products were SPI, SPC and a combination of SPI, PPC and WS, respectively. Soy protein concentrate (SPC; Arcon® SB, 90% dry matter with 65% protein, 4% fat and 7% ash) was purchased from Archer Daniels Midland Company (USA).

For making products (A) and (B) mentioned above and their respective plant protein-only controls, Soy protein isolate (SPI; SUPRO 500E IP, 94% dry matter with 90% protein, 1% fat, and 5% ash) was purchased from Solae (Winnipeg, USA). The composition of beef and chicken mince was approx. 64 and 71% moisture; 16 and 4% fat; and 18 and 26% protein, respectively.

For making product (C) mentioned above and their respective plant protein-only controls, Soy protein isolate (SPI) (PROFAM 974) was purchased from Archer Daniels Midland Company (Chicago, IL, USA). The protein, fat, moisture and ash content of the SPI were approximately 85.61 g±0.22 g/100 g (dry basis), 0.3%, 5.76 g±0.26 g/100 g and 4.28 g±0.30 g/100 g, respectively. The exogenous polysaccharides from WS (FLOURCW25, 0.4% protein, 12.1% moisture, 0.5% ash and 87% carbohydrate) were purchased from Davis Trading Company (Palmerston North, New Zealand). Milk protein concentrate (MPC) were supplied by Fonterra Co-operative Group Ltd. (Auckland, New Zealand). The PPC was also purchased from the Davis Trading Company (Palmerston North, New Zealand) and had moisture content of 6.4%±0.2; Protein 77.39%±0.45; fat, 0.34%; and ash content of 8.09%±0.76.

Control samples of beef cheeks and chicken thighs were also prepared for comparison of textural properties.

### Preparation of Beef Cheeks

The surrounding fat layers from were removed from the beef cheek samples (average about 380 g) before vacuum packaging and subjecting the samples to sous vide cooking for 24 and 48 h in a water bath preheated at 58° C. The samples were removed from the water bath and were immediately transferred to the chiller at 4° C. before being cut to the desired dimensions for texture analysis.

### Preparation of Chicken Thighs

Fresh chicken thigh samples were skinned and weighed before vacuum packing. The samples were then sous vide cooked in a water bath for 30 min at 70° C. After cooking, the samples were patted dry and transferred to an electric hot skillet (ZIP non-stick electric skillet 26 cm dia.) with a maintained surface temperature of 90° C. Each sample was cooked for 2.5 min per side. The cooked samples were left at room temperature for 10 min before they were patted dry and weighed again to estimate cooking loss. The samples were then transferred to the chiller at 4° C. before being cut to the desired dimensions for texture analysis

### Textural Analysis

For each sample type, at least three measurements were taken for Textural Profile Analysis (TPA) and cutting force analysis.

### TPA Profiling (Two Bite Test)

The TPA analysis was done using a Texture analyser (TA.XT Plus, Stable Micro Systems, UK) by slightly modifying the method by Chen et al (2010) with slight modification. Briefly, the samples were cut into a square shape (15 mm×15 mm×15 mm) and placed on the stage in an orientation that the fibre direction was perpendicular to the probe. These samples were compressed twice using a P/51 probe to 50% of their original shape at a speed of 1.00 mm/s and then returned to the pre-test position over 5 sec. The test was performed at a trigger force of 0.049 N and the test was done in triplicate.

The following parameters were calculated from the TPA curves as shown in FIG. 5 (https://texturetechnologies.com/resources/texture-profile-analysis #select-characteristics).

Hardness is obtained by observing the maximum load reached (Force 2) during the first deformation cycle. It is related to the stiffness of the material.

Cohesiveness corresponds to the ratio between the area under the time/force curve during the second cycle divided by the area during the first cycle. This parameter is related to the consistency of the material. If the material withstands the first cycle without disintegrating, the value will be close to 1, but if it disintegrates completely, it will be close to zero.

$$Cohesiveness = \frac{FT 4 : 6}{FT 1 : 3}$$

Gumminess characterises semi-solid foods and is a function of cohesiveness and hardness.

Gumminess=cohesiveness x hardness.

Springiness corresponds to the ratio between the time needed for the material to reach the maximum load since it starts to deform in the second cycle (Time Difference4:5) and the time needed for the first cycle (Time Difference 1:2). This parameter is related to the recovery of the material and its viscoelastic properties.

$$Springiness = \frac{Time Difference 4 : 5}{Time Difference 1 : 2}$$

Chewiness is a parameter obtained by multiplying the hardness times the cohesiveness times the springiness. It is related to how easily a material can be bitten.

Chewiness=(hardness×cohesiveness)×springiness

Resilience is calculated by dividing the upstroke area (Area2:3) by the downstroke area (Area1:3) of the first compression cycle. It is related to the plastic deformation of the material. If the material does not deform plastically its value will be one but if the material does not recover its shape after the first compression cycle, its value will increase.

$$Resilience = \frac{Area 2 : 3}{Area 1 : 2}$$

### Warner Bratzler Test (Cutting Strength)

The cutting force required by the meat analogues was analysed using a compression test with a Warner Bratzler blade. It is a V-notched “blade” that exerts a shear cutting movement over a cylinder-shaped sample. In contrast with the double compression test (TPA), this technique simulates best the cutting effect rather than the chewing. These two parameters are widely accepted methods for mechanical assessment of food texture. The area of force required corresponds to the toughness of the meat analogue. This process was modified from the procedure outlined by Chen et. al (2010).

The sample was cut into a rectangular shape of 15 mm×15 mm with the length determined by how much could be cut from the analogue maintaining the required thickness. A minimum length of approximately 40 mm is required for one cut as an overhang is essential for valid data.

Further cuts in one sample can be undertaken, given overhang is present.

The compression occurred at a speed of 2.00 mm/sec for a distance of 45.00 mm. The sample was placed so the fibres ran perpendicular to the blade (horizontal) to test cross-wise strength.

The test was performed with a trigger force of 0.049 N and each sample was tested in triplicate.

### Statistical Analysis

Data plotting and statistical analysis (one-way analysis of variance and Tukey's multiple comparison test) were performed using Minitab software (Minitab version 16; Minitab, Inc., State College, PA, USA). Differences were considered to be statistically significant at a level of p<0.05.

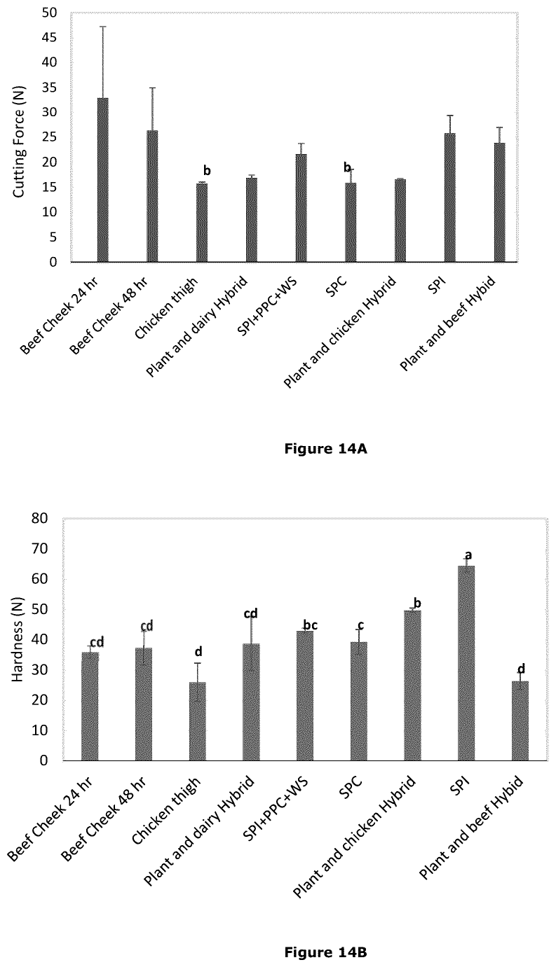

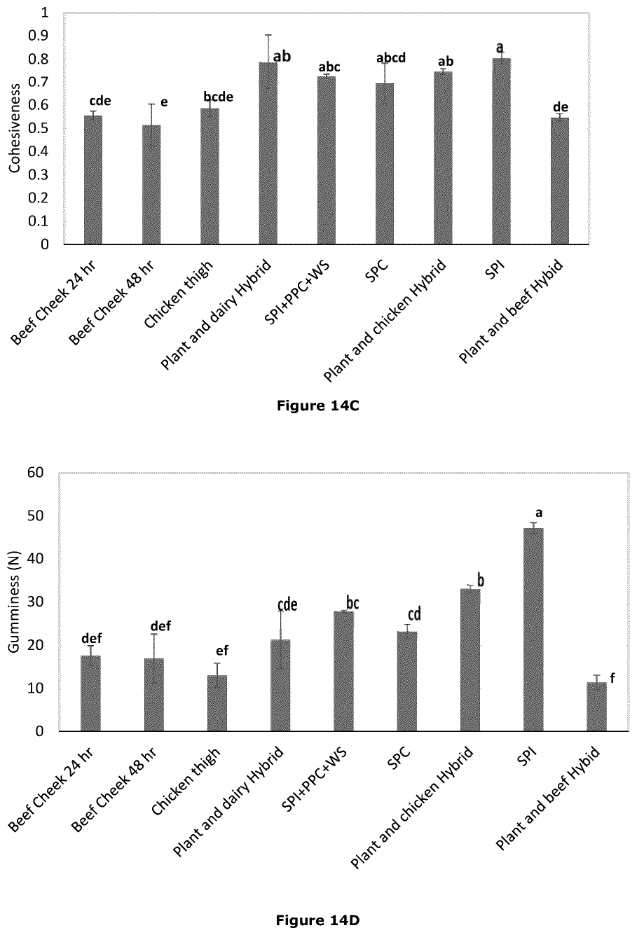

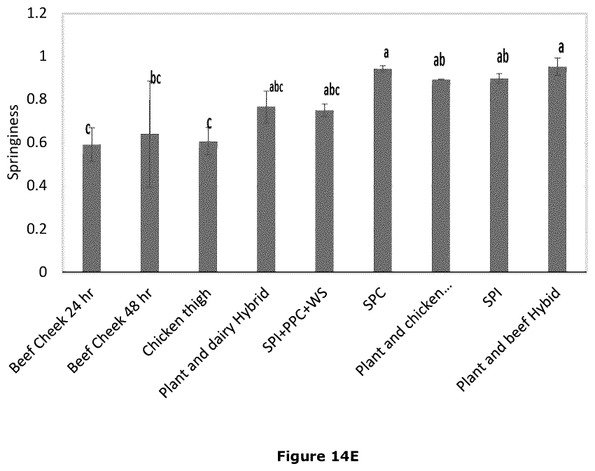

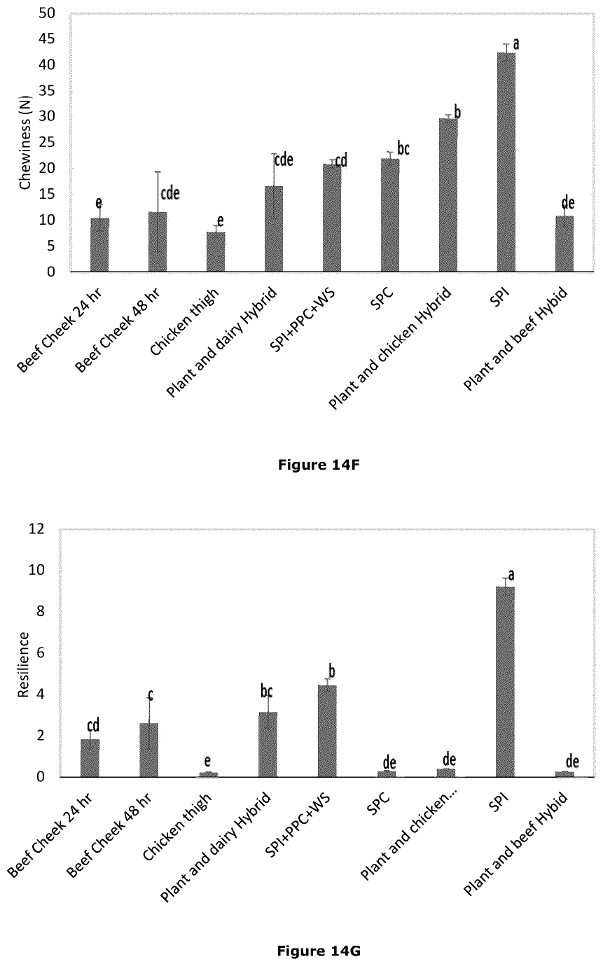

The results are shown in FIG. 14 and Table 13. Table 13 shows if the textural parameters for the plant-protein only and plant-dairy, plant-chicken and plant-beef samples are statistically (p<0.05) similar (1) or different (x) to cooked beef cheeks (sous vide cooked for 24 an 48 h) and cooked chicken thighs.

TABLE 13
Overall textural analysis comparison

| Textural | Plant + | Plant + | Plant + | | | |
|---|---|---|---|---|---|---|
| parameter | dairy | beef | chicken | SPI | SPC | SPI+PPC+WS |
| Cutting Force | ✓ | ✓ | ✓ | ✓ | ✓ | ✓ |
| | | | | | (only x to | |
| | | | | | beef | |
| | | | | | cheeks | |
| | | | | | cooked | |
| | | | | | for 24 h) | |
| Hardness | ✓ | ✓ | x | x | ✓ | ✓ |
| Cohesiveness | ✓ | ✓ | ✓ | x | ✓ | ✓ |
| | (same as | | (same as | | (only x to | (only x to |
| | chicken | | chicken thighs | | beef | beef cheeks |
| | thighs | | but x to beef | | cheeks | cooked for |
| | but x to | | cheeks) | | cooked | 48 h) |
| | beef | | | | for 48 h) | |
| | cheeks) | | | | | |
| Gumminess | ✓ | ✓ | x | x | ✓ | ✓ |
| | | | | | (only x to | |
| | | | | | chicken | |
| | | | | | thighs) | |
| Chewiness | ✓ | ✓ | x | x | ✓ | ✓ |
| | | | | | (only x to | (only x to |
| | | | | | chicken | chicken |
| | | | | | thighs | thighs and |
| | | | | | and beef | beef cheeks |
| | | | | | cheeks | cooked for |
| | | | | | cooked | 24 h) |
| | | | | | for 24 h) | |
| Springiness | ✓ | x | ✓ | ✓ | x | ✓ |
| | | | (only x to | (only x | | |
| | | | chicken | to | | |
| | | | thighs and | chicken | | |
| | | | beef cheeks | thighs | | |
| | | | cooked for | and | | |
| | | | 24 h) | beef | | |
| | | | | cheeks | | |
| | | | | cooked | | |
| | | | | for 24 h) | | |
| Resilience | ✓ | ✓ | ✓ | x | ✓ | x |
| | (only x | (only x to | (only x to | | (only x to | |
| | to | beef | beef cheeks | | beef | |
| | chicken | cheeks | cooked for 48 | | cheeks | |
| | thighs) | cooked for | h) | | cooked | |
| | | 48 h) | | | for 48 h) | |

FIG. 14 and Table 13 show that the process of the invention produces hybrid meat analogue products with textures similar to genuine meat. Accordingly, this process solves the problems associated with incorporating texture into meat-containing compositions, which cannot be successfully extruded.

### 7. REFERENCES

Ba-Jaber. A. S., Maga. J. A., Schmidt. G. R. & Sofos. J. N. (1992) Extrusion Cooking of Chicken Meat With Various Non Meat Ingredients Development in Food Science (29) pp 761-782 DOI: 10.1016/B978-0-444-888-34-1.50067-3.
Boom. R., Dekkers. B., & van der Goot. A. J. (August 2018) Structuring processes for meat analogues Trends in Food Science &Technology 81 DOI 10.1016/j.tifs.2018.08.011
Bourne, M. (2002). Food texture and viscosity: concept and measurement. Elsevier.
Chen, C., Wang, R., Sun, G., Fang, H., Ma, D., & Yi, S. (2010). Effects of high pressure level and holding time on properties of duck muscle gels containing 1% curdlan. Innovative Food Science & Emerging Technologies, 11(4), 538-542. doi:https://doi.org/10.1016/j.ifset.2010.05.004
Chiang. J. H., Hardacre. A. K., Loveday. S. M. & Parker. M. E. (January 2019) Effects of soy protein to wheat gluten ratio on the physicochemical properties of extruded meat analogues Food Structure 19 DOI 10.1016/j.foostr.2018.11.002
Das, Arun K., Anjaneyulu, A. S. R., Gadekar, Y. P., Singh, R. P., Pragati, H., (2008) Effect of full-fat soy paste and textured soy granules on quality and shelf-life of goat meat nuggets in frozen storage Meat Science, 80(3), 607-14.
Hegarty, P. V. J., & Ahn, P. C. (1976). Nutritional comparisons between a soy-based meat analog and ground beef in the unheated and heated states. Journal of Food Science, 41(5), 1133-1136.
Knoch, A. (2016). Production of restructured meat-like products by high moisture extrusion technology. In Geoffrey W Smithers [Ed.], In Reference Module in Food Science. Amsterdam: Elsevier.
Liu, S. X., Peng, M., Tu, S., Li, H., Cai, L., & Yu, X. (2016). Development of a new meat analog through twin-screw extrusion of defatted soy flour-lean pork blend. Food Science and Technology International, 11(6), 463-470. doi:10.1177/1082013205060130
Paula, A. M., & Conti-Silva, A. C. (2014i). Texture profile and correlation between sensory and instrumental analyses on extruded snacks. Journal of Food Engineering, 121, 9-14. doi:10.1016/j.jfoodeng.2013.08.007
Shackelford, S., Wheeler, T., & Koohmaraie, M. (1999). Evaluation of slice shear force as an objective method of assessing beef longissimus tenderness. Journal of Animal Science, 77, 2693-2699.
Zarzycki, P., Rzedzicki, Z., Sobota, A., & Pawlas, A. (2016). The effect of plant-meat blends composition and extrusion temperature on the physical properties of extrudates. Acta Agrophysica, 23(4). 705-717.

1. A method for producing a texturised hybrid meat analogue, the method comprising:
(a) combining at least one source of plant protein and at least one source of animal protein with water to form a protein composition with a moisture content of about 40 to about 70%,
(b) injecting high pressure steam into the protein composition in a sealed vessel while applying shear, until the protein composition reaches about 120 to about 150° C.,
(c) continuing to apply shear to the protein composition in the sealed vessel for about 5 to about 45 minutes while maintaining the temperature and moisture of the composition,
(d) allowing the protein composition to cool, to provide a texturised hybrid meat analogue.

2. The method according to claim 1 wherein the protein composition comprises a source of plant protein and a source of animal protein in a ratio of about 60:40 to about 95:5, preferably about 70:30 to about 80:20.

3. The method according to claim 1 wherein the source of plant protein is a plant protein powder selected from the group consisting of SPI, SPC, TVP, YPF, wheat gluten, black bean protein powder, chickpea protein powder, pea protein powder, broad bean protein powder, mung bean protein powder, rice protein concentrate, potato protein, grass protein and lupin protein, preferably SPI, PPC and YPF.

4. The method according to claim 1 wherein the source of animal protein is selected from the group consisting of meat, powdered dairy protein and powdered insect protein.

5. The method according to claim 1 wherein the protein composition comprises about 60-90% SPI to about 10-40% BT, wherein the relative amounts of SPI and BT equal 100%.

6. The method according to claim 1 wherein the protein composition comprises about 60-80% plant protein powder to about 40-20% chicken, wherein the relative amounts of plant protein powder and chicken equal 100%.

7. The method according to claim 6 wherein the plant protein powder comprises about 30-50% SPI to about 50-70% PPC, wherein the relative amounts of SPI and PPC equal up to 100%.

8. The method according to claim 1 wherein the protein composition comprises about 20-45% SPI to about 20-45% PPC to about 10-40% MPC, wherein the relative amounts of SPI, PPC and MPC equal 100%.

9. The method according to claim 1 wherein the protein composition is heated to about 130 to about 140° C., in the sealed vessel in step (b) while shear is continually applied to the composition.

10. The method according to claim 1 wherein the pressure in the sealed vessel reaches about 2-3 bar in step (b).

11. Th method according to claim 1 in which prior to rapid heating by steam injection, the protein composition is pre-heated to about 60 to about 80° C., preferably about 65 to about 75° C., more preferably about 70° C.

12. The method according to claim 1 wherein the method is carried out in a mixer comprising a sealable vessel that includes at least one steam inlet, wherein the mixer includes mixing apparatus capable of applying shear to the vessel contents.

13. The method according to claim 1 wherein the sealed vessel applies shear by way of a mixing wheel and an agitator comprising one or more arms, wherein the mixing wheel and agitator arms rotate in opposite directions.

14. The method according to claim 13 wherein the mixing wheel rotates at about 50 to about 100× faster than the agitator, preferably about 80× faster.

15. The method according to claim 1 wherein the temperature, moisture and shear conditions within the sealed vessel are maintained for about 5, 10 or 15 to about 30 minutes in step (c).

16. (canceled)

17. A texturised hybrid meat analogue comprising a source of plant protein and a source of animal protein in a ratio of about 60:40 to about 95:5, wherein the proteins fibres are substantially aligned.

18. A textured hybrid meat analogue comprising about 60-90 SPI to about 10-40 BT, wherein the relative amounts of SPI and BT equal 100%, and wherein the hardness of the meat analogue is within up to 50% of the hardness of chicken breast when vacuum packed and boiled in water at 98° C. for 10 min.

19. (canceled)

20. The textured hybrid meat analogue according to claim 17 which has at least one of the following properties:
(a) a hardness of at least about 15N,
(b) a cutting force of at least about 10N,
(c) a cohesiveness of less than about 0.85,
(d) a gumminess of between about 8N and about 40N,
(e) a springiness of greater than about 0.4, preferably about 0.6 to about 0.8, and
(f) a chewiness of about 5N to about 35N;
when a 15 mm³ sample is analysed by double compression using a P/51 probe to 50% of its original size at a speed of 1.00 mm/s and then allowed to return to the pre-test position over 5 s.

21. The textured hybrid meat analogue according to claim 18 which has at least one of the following properties:
(a) a hardness of at least about 15N,
(b) a cutting force of at least about 10N,
(c) a cohesiveness of less than about 0.85,
(d) a gumminess of between about 8N and about 40N,
(e) a springiness of greater than about 0.4, preferably about 0.6 to about 0.8, and
(f) a chewiness of about 5N to about 35N;
when a 15 mm³ sample is analysed by double compression using a P/51 probe to 50% of its original size at a speed of 1.00 mm/s and then allowed to return to the pre-test position over 5 s.
